(19) United States
(12) Patent Application Publication
(10) Pub. No.: US 2002/0065823 A1
(43) Pub. Date: May 30, 2002

(54) Fast file retrieval polyalgorithm

(76) Inventors: Brendan Boulter, Galway (IE); Ciaran Murphy, Dublin (IE)

Correspondence Address: NIXON & VANDERHYE P.C., 8th Floor, 1100 North Glebe Rd., Arlington, VA, 22201-4714, US

(21) Appl. No.: 09/828,154

(22) Filed: Apr. 9, 2001

(30) Foreign Application Priority Data
Nov. 28, 2000 (GB) 0028893.6

(51) Int. Cl. G06F 7/00

(52) U.S. Cl. 707/7

(57) ABSTRACT

A data structure for storing file header and body information and a polyalgorithm for locating a file in an embedded file system. File headers are stored consecutively and together in an evenly spaced sequence and contain pointers to their respective variable length bodies that are stored separately. The files are located by selecting a file header that is at the mid point of the header index, comparing whether the required file index position is higher or lower than the mid point header and confining the search range to the half of the index in which the required file is located. The procedure is then repeated, several times if necessary, each time looking at the mid point header of the range of headers currently in the search, confining the range and so on until either the file is located or the search space becomes zero. Usefully, the search may switch to a linear search when the range has been substantially reduced.

### FIELD OF THE INVENTION

This invention relates to file structures and file retrieval, and more particularly to fast retrieval of files from a static preordered file system.

In such systems the usual general characteristics are that the file system is stored in the device's flash memory, the file system is static in the sense that new files will not be created nor will existing files be deleted, and the files in each directory are alphabetically ordered.

### BACKGROUND OF THE INVENTION

System response times are sensitive to various factors, one of which is the finding and accessing of files required by an application. In uses such as Web Interfaces response time is increasingly important to enable user satisfaction but the Web interfaces requires many files in rapid succession during initial loading.

A typical file structure includes a header followed by a body. The header is of a fixed length and contains information including the identity of the file and the length of the subsequent body, which can be variable. A first file header and body is then followed by a second file header and body and so on.

When it is desired to retrieve a file, the list of files is searched via a linear linked-list technique in which the headers are searched in turn until the required file is found, when the search function returns the address and length of the file body. If there is not a match between the required file and the searched header, the search function uses the address of the next header that is stored in the first header to find its way to the next header. It is necessary to store the address of the next following header in each header because not all files are of the same length. The search proceeds until there is a match with the requested file, or there are no more files to be found.

In the worst case scenario, when the file to be retrieved turns out to be the last file, then the order of n steps ο (n) are required.

### SUMMARY OF THE INVENTION

The present invention is directed towards reducing the time taken to search for a file and also to reduce the number of pointers required.

According to one aspect of the invention there is provided a file structure for a static preordered file system comprising a block of memory having file headers grouped together in an evenly spaced sequence, the file bodies being stored separately and accessible from information in the corresponding header.

According to another aspect of the invention there is also provided a file structure and file location method comprising having file headers located in an evenly spaced sequence and locating a required file by, a) selecting a file header that is at the mid point of said evenly spaced sequence, b) determining whether the index position of the required file is higher or lower than the mid point header, c) confining the search range for the next step to the half range above or below the mid point header in which it has been determined the required file has its index, d) selecting a file header that is at the mid point of the search range established in step (c), and e) repeating steps b, c and d until a match for the required file is found or the search ended.

In order to evenly space the headers, the file director is reordered so that all the headers are contained in a continuous block of memory, the file bodies being stored separately at an address contained in the file header.

The invention also provides a search method for locating a file in an embedded file system that combines the above fast file location with a slow linear search technique.

The fast file location method locates files in the order of log n steps—ο (log n) while the linear method requires of the order of n steps ο (n)

The techniques may be applied or combined in several ways, for example:

a) a file search can utilise the fast method for large directories, over a predetermined size, or the slow search for small directories, under a predetermined size. The predetermined size may depend upon or be chosen in accordance with other system characteristics

b) a file search may start using the fast method and switch to the slow method when the search space has been reduced to a suitably small size or predetermined size as indicated above

c) The slow method may be invoked after the fast method in order to return information about the next file in sequence

d) The slow method may be used to traverse the directory for example to list the files in order

The fast location method operates using recursive halving, the search space being iteratively reduced (halved) until either the file is found or the search space is zero.

More specifically for n headers, the first header examined is n/2 and if it is not a match the file name is compared with the required file name to see whether the required file is higher or lower. The search is then restricted to the respective higher or lower half of the headers containing the required file and the next header to be examined is the header mid way in that half ie n/4 or 3n/4.

Each header block is of a fixed length, and spaced from adjacent headers by a constant gap. Hence any file header can be accessed with an indexed jump rather than using pointers.

Once the correct file is located, the header contains a pointer to the respective file body.

### BRIEF DESCRIPTION OF THE DRAWINGS

FIG. 1 is a schematic diagram of a prior art file structure.

FIG. 2 is a schematic diagram of a file structure according to the present invention.

FIG. 3 is a flow diagram of the method according to the present invention.

### DETAILED DESCRIPTION OF A PREFERRED EXAMPLE

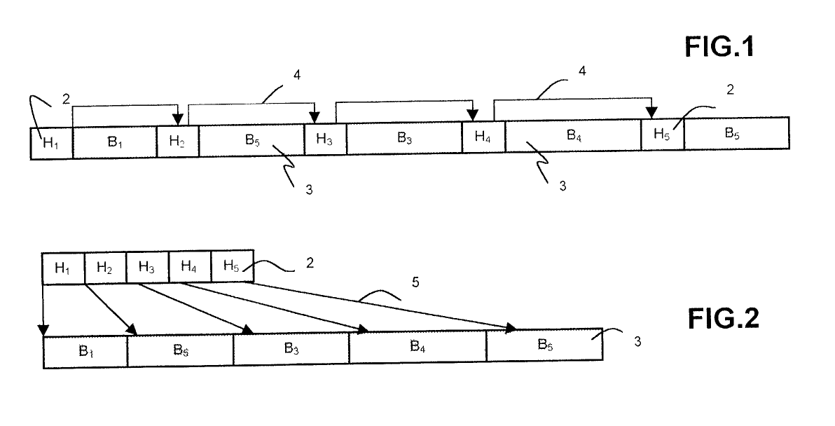

Referring to FIG. 1 of the drawings, a typical file structure 1 of the prior art is shown. Each file has a header 2 marked H₁, H₂ etc in the drawing. Each header is followed by a body 3, marked B₁, B₂ etc in the drawing. The headers have a fixed length and contain information in a fixed number of fields, including the file name, the length of the body and the address of the next header, as that can be a variable length from the preceding header depending on the length of the intervening body. The pointer to the subsequent header is represented by arrows 4.

Files are located in this structure by searching linearly through the file headers until the correct file is retrieved. In the worst case, the search has to continue through all the headers, requiring ο (n) steps where there are n files. An average of ο (n/2) steps are required more generally.

The present invention proposes a different file structure as shown in FIG. 2. In this structure the headers 2 are arranged in a continuous block. In this context continuous means without an intervening, variable length body.

As the headers are of the same length the spacing from the start of one header to the next is the same. In practice, the headers will also be separated by a small constant interval. In the context of the present invention ‘continuous’ includes headers separated by constant intervals. Each header has a pointer 5 to its associated body, which is located elsewhere in the memory. Grouping the headers in this way makes it possible to jump from header to header based on the index number of the header and the fixed interval. In itself this enables a fast linear traverse of the file system without use of pointers between each header. A linear traverse in this manner may be used to generate a directory listing or for searching in small directories.

However, in many instances, it is desirable to reduce the number of file headers searched especially in large directories. The present invention achieves this by examining the header in the middle of the search range, and (unless it happens to be the required file) comparing the required file index with the mid range index to see whether the required file lies in the higher (on right) half of the search range or the lower (on left) half of the search range.

The search range is then redefined as the half range in which the required file is determined to be located by the index comparison and the mid point header of the new search range is examined and compared, then the range halved again. If at any time the mid range header turns out to be the required header then the search ends. If the search space is reduced to zero the search ends with the file not found.

The recursive halving of the search range provides a maximum number of steps of only ο (logn).

It is possible if desired to revert to a linear search through the headers once the range has reduced to a size where the overhead of repeating the recursive algorithm is higher than a linear search through the reduced range. There may also be other reasons for switching to alinear search for part of or the end of a search.

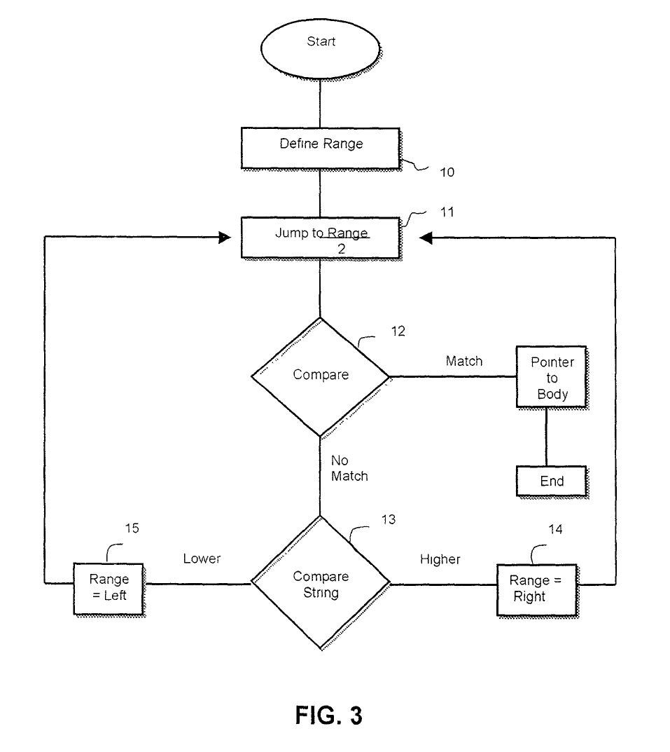

FIG. 3 illustrates a simplified flow diagram of steps in performing a search method according to the invention.

In FIG. 3 box 10 represents the step of finding the file or part file that is to be searched, and in box 11 the search jumps to the mid range header. The header is then compared, box 12, and if there is a match the search ends. If there is no match the required file index is compared (box 13) fith the mid range header index to see if it is higher or lower in the file order. If higher the search range is then redefined as the higher or right half of the previous search range (box 14), or if lower the range is redefined as the lower or left half (box 15).

The search then jumps to the middle of the newly defined range by returning to box 11.

Other steps (not shown) may be added in to this procedure.

For example at the Define Range stage 10 a check on the size of the file may be made to see if it is greater or less than a predetermined size, and if it is less to use the slower linear form of search. Other instructions or tests to adopt the linear search for other reasons may also be incorporated at this stage. Similar size checks may also be located after each redefinition of the range, for example after boxes 14 and 15, and the search switched to the linear technique. There may be other instructions such as listing a sequence of files that can be incorporated using combinations of fast and slow search methods.

1. A file structure for a static, preordered file system comprising a block of memory having file headers grouped together in an evenly spaced sequence, the file bodies being stored separately and accessible from information in the corresponding header.

2. A file structure and file location method comprising:
having file headers located in an evenly spaced sequence and locating a required file by,
a) selecting a file header that is at the mid point of said evenly spaced sequence,
b) determining whether the index position of the required file is higher or lower than the mid point header,
c) confining the search range for the next step to the half range above or below the mid point header in which it has been determined the required file has its index,
d) selecting a file header that is at the mid point of the search range established in step (c), and
e) repeating steps b, c and d until a match for the required file is found or the search ended.

3. The method of claim 2 in which the search is ended when the half range containing the required file is below a predetermined size.

4. The method of claim 3 in which the half range below said predetermined size is searched linearly.

5. The method of claim 2 in which the mid point headers are selected by indexed jumps.

6. The method of of claim 2 to 5 in which the headers contain pointers to their respective file bodies.
